(19) United States
(12) Patent Application Publication
(10) Pub. No.: US 2016/0314419 A1
(43) Pub. Date: Oct. 27, 2016

(54) NEAR-FIELD COMMUNICATION LABELS FOR STORE SHELVES

(71) Applicant: Wal-Mart Stores, Inc., Bentonville, AR (US)

(72) Inventors: Richard Andrew White, Pineville, MO (US); Christopher Soames Johnson, Pea Ridge, AR (US); Ricky L. Lewis, Rogers, AR (US); Jimmie R. Clark, Fayetteville, AR (US); Anita Dawn Atuegbu, Bentonville, AR (US)

(21) Appl. No.: 15/137,249

(22) Filed: Apr. 25, 2016

Related U.S. Application Data
(60) Provisional application No. 62/153,064, filed on Apr. 27, 2015.

(51) Int. Cl. G06Q 10/06; H04W 4/00; G06Q 10/08

(52) U.S. Cl. CPC G06Q 10/06311; G06Q 10/087; H04W 4/008

(57) ABSTRACT

A method and system for facilitating self-shopping in an enterprise comprise a support surface for supporting items. The support surface has a near-field communication (NFC) label coupled thereto. A computing system receives a radio frequency (RF) communication transmitted by a mobile device in response to the mobile device being placed near enough to the NFC label to read the NFC label. The RF communication conveys information read from the NFC label. The computing system comprises a processor programmed to determine an item associated with the NFC label based on the information conveyed by the RF communication, determine that the support surface has an insufficient quantity of the item, and cause a message to be automatically transmitted an electronic message to personnel indicating that the shelf requires restocking of the item.

### RELATED APPLICATION

This application claims priority to U.S. Provisional Application Ser. No. 62/153,064, filed on Apr. 27, 2016 entitled “Near-Field Communication Labels for Shelves”, the entirety of which is incorporated by reference herein.

### FIELD

This specification relates generally to self-shopping systems and, more specifically, to self-shopping systems that place near-field communication (NFC) labels on store shelves to communicate product information to NFC-enabled devices used by shoppers.

### BACKGROUND

Various emergent technologies are enhancing the shopping experience. One example is the use of QR Codes (quick response code). A QR Code is an optical barcode containing information about the item with which the QR Code is associated. Users can use a camera on their smartphones to scan the QR Code. An application running on the smartphone communicates with a network of the retailer to obtain product information associated with the scanned QR Code. However, optically scanning items in a store with a smartphone camera can be slow, error prone and occasionally impractical because of poor lighting or obstructed access to the item with the barcode.

### SUMMARY

All examples and features mentioned below can be combined in any technically possible way.

In one aspect, a method for facilitating self-shopping comprises receiving, at a computing system, a radio frequency (RF) communication conveying information read by a mobile device from a near-field communication (NFC) label coupled to a shelf. The computing system determines an item associated with the NFC label based on the information conveyed by the RF communication. The computing system determines, in response to the RF communication, that the shelf has an insufficient quantity of the item. In response to determining that the shelf has an insufficient quantity of the item, the computing system automatically transmits an electronic message to personnel indicating that the shelf requires restocking of the item.

Embodiments of the method may include one of the following features, or any combination thereof.

In some embodiments, the information conveyed by the RF communication includes a quantity of the item added to an electronic cart by a user of the mobile device. The method may further comprise computing the quantity of the item remaining on the shelf in response to the quantity of the item added to the electronic cart, with the computing system determining the shelf has an insufficient quantity of the item when the computed quantity is less than a predefined number.

The method may further comprise offering an alternative item if the RF communication indicates the shelf has an insufficient quantity of the item. A discount coupon may be provided for the alternative item. In addition, the method may further comprise redirecting a user of the mobile device to a different location within the enterprise to find the item if the RF communication indicates the shelf has an insufficient quantity of the item.

In some embodiments, the method may further comprise tracking a path through the enterprise taken by a user of the mobile device based on each location in the enterprise where the mobile device communicates with the computing system in response to reading an NFC label.

In another aspect, a system for facilitating self-shopping in an enterprise comprises a support surface for supporting items. Coupled to the support surface is a near field communication (NFC) label. The system further comprises a computing system with a receiver that receives a radio frequency (RF) communication transmitted by a mobile device in response to the mobile device being placed near enough to the NFC label to read the NFC label. The RF communication conveys information read from the NFC label. The computing system comprises a processor programmed to i) determine an item associated with the NFC label based on the information conveyed by the RF communication, ii) determine in response to the RF communication that the shelf has an insufficient quantity of the item, and iii) cause a message to be automatically transmitted an electronic message to personnel indicating that the shelf requires restocking of the item.

Embodiments of the system may include one of the following features, or any combination thereof.

In some embodiments, the information conveyed by the RF communication includes a quantity of the item added to an electronic cart by a user of the mobile device. The processor may be further programmed to offer an alternative item if the RF communication indicates the support surface has an insufficient quantity of the item, and optionally provide a discount coupon for the alternative item. The processor may be further programmed to redirect a user of the mobile device to a different location within the enterprise to find the item if the RF communication indicates the support surface has an insufficient quantity of the item.

In some embodiments, the processor may be further programmed to track a path taken by a user of the mobile device through the enterprise based on each location in the enterprise where the mobile device communicates with the computing system in response to reading an NFC label.

In another aspect, computer program product for facilitating self-shopping comprises a non-transitory computer readable storage medium having computer readable program code embodied therewith. The computer readable program code comprises computer readable program code that, if executed, receives a radio frequency (RF) communication conveying information read by a mobile device from a near-field communication (NFC) label coupled to a shelf, computer readable program code that, if executed, determines an item associated with the NFC label based on the information conveyed by the radio frequency communication, computer readable program code that, if executed, determines in response to the radio frequency communication that the shelf has an insufficient quantity of the item, and computer readable program code that, if executed, automatically transmits an electronic message to personnel indicating that the shelf requires restocking of the item.

Embodiments of the computer program product may include one of the following features, or any combination thereof.

The information conveyed by the RF communication may include a quantity of the item added to an electronic cart by a user of the mobile device. The computer program product may further comprise computer readable program code that, if executed, computes the quantity of the item remaining on the shelf in response to the quantity of the item added to the electronic cart by the user of the mobile device, and computer readable program code that, if executed, determines the shelf has an insufficient quantity of the item when the computed quantity is less than a predefined number.

The computer program product may further comprise computer readable program code that, if executed, offers an alternative item if the RF communication indicates the shelf has an insufficient quantity of the item, and, optionally, computer readable program code that, if executed, provides a discount coupon for the alternative item.

The computer program product may further comprise computer readable program code that, if executed, redirects a user of the mobile device to a different location within the enterprise to find the item if the RF communication indicates the shelf has an insufficient quantity of the item. In some embodiments, the computer program product may further comprise computer readable program code that, if executed, tracks a path taken by a user of the mobile device through the enterprise based on each location in the enterprise where the mobile device communicates with the computing system in response to reading an NFC label.

### BRIEF DESCRIPTION OF THE DRAWINGS

The above and further features and advantages may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 is a diagram of an embodiment of an enterprise including a computing system and a shelf having items and near-field communication labels.

FIG. 2 is a flow diagram of an embodiment of a process for facilitating self-shopping in the enterprise.

FIG. 3 is a flow diagram of an embodiment of a process for enhancing the shopping experience of a shopper who finds a shelf of desired items to have an insufficient number of such items.

### DETAILED DESCRIPTION

Systems and methods described herein facilitate and enhance the “self-shopping” process within an enterprise, examples of which include, but are not limited to, supermarkets, warehouse stores, wholesale clubs, retail stores, and department stores. Near field communication (NFC) labels placed on shelves, or on the edges of shelves, provide information about the items on those shelves. In general, near-field communication involves technology by which NFC-enabled devices can communicate with each other, through radio signals, by touching or coming into proximity (e.g., less than 4 inches). A shopper moves an NFC-enabled mobile device near an NFC label to acquire information about the item associated with that NFC label. An application program running on the mobile device can display information, for example, a description of the associated item.

The application program can also communicate with a computer system of the enterprise over a radio-frequency link, passing along information acquired from the NFC label. Based on this received information, the enterprise accesses a product database and returns relevant details about the item to the mobile device. Examples of such relevant details include, but are not limited to, price, discount offers based on quantity purchased, and discount coupons. With the mobile device running the application program, the shopper may add the item to an electronic shopping cart, specifying a desired quantity of the item. The application program may maintain a running total of the amount being purchased by the shopper. At checkout, the shopper can bring the mobile device to an NFC reader coupled to a cash register. The communication exchange between the mobile device and NFC reader determines the amount the shopper is to pay.

In some instances, the shopper may find the shelf to be empty or to have fewer items than desired. Through the application program, the shopper can notify the enterprise of the situation. (Advantageously, by affixing NFC labels to shelves, as opposed to the items themselves, when the shelf is empty, and the items are no longer available, the shopper can still identify and report the under stocked item by scanning the NFC label.) The enterprise can respond to this notification in one or more ways, including, but not limited to, searching inventory for more of the items, redirecting the shopper to another area of the enterprise where more of the items may be found, offering a discount coupon for the under stocked item or for an alternative item, and notifying personnel of the under stocked shelf. In some embodiments, the enterprise can determine from the communication that the shelf has become under stocked, for example, by taking into account the number of items placed into the shopping cart of the shopper. In response, the enterprise can notify personnel of the under stocked shelf, unbeknownst to the shopper.

The shopper can acquire the application program used to communicate with the NFC labels and the enterprise computer system from any one of a variety of sources. For example, the shopper may obtain the application program from an online application store. Alternatively, the shopper may download the application program upon entering the premises of the enterprise and establishing a radio frequency connection with the enterprise network. As another example, the shopper may acquire the application program from a NFC-enabled kiosk or other such NFC-enabled station, disposed where the shopper enters the premises or near where the shopper is likely to pass by; the shopper can download the application program by tapping the mobile device to the station.

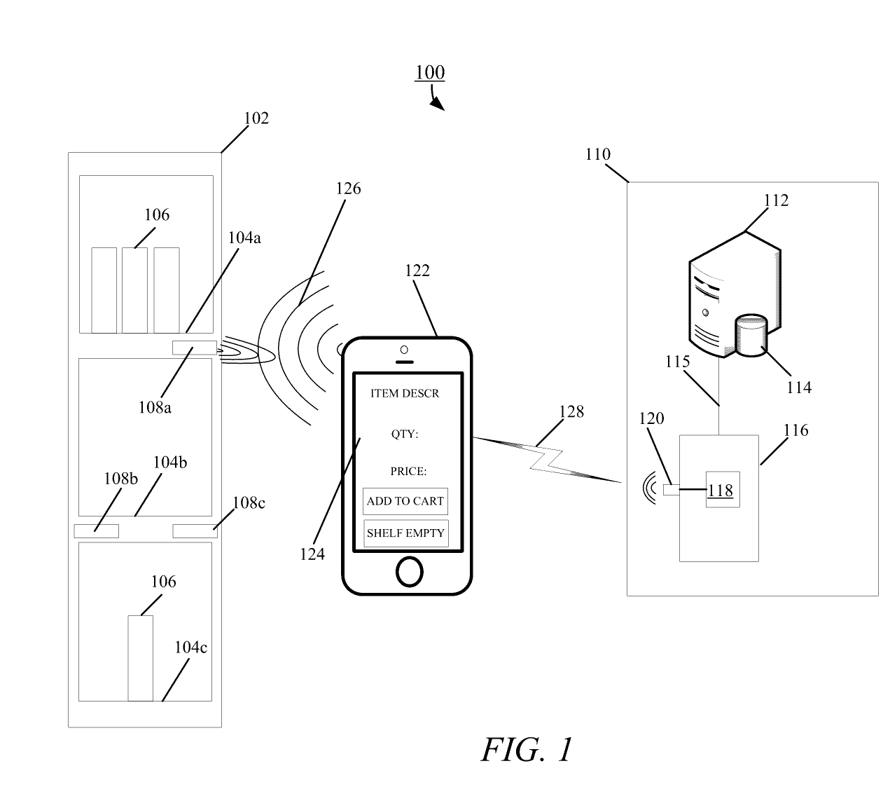

FIG. 1 shows an embodiment of an enterprise 100 including a display case 102 with shelves 104a, 104b, 104c (generally, shelf 104) supporting items 106. Adjacent to each shelf 104 is one or more NFC labels 108a, 108b, and 108c (generally, NFC label 108). Each NFC label 108 is associated with one type of item 104, typically located near that NFC label 108.

Each shelf 104 is, generally, an example embodiment of a support surface for holding items 106. The principles described herein may be practiced with other types of support surfaces, such as tables, displays, counters, and racks. Items 106 are generally products offered by the enterprise 100 for sale.

Each NFC label 108 includes storage memory (not shown), a radio chip (not shown) coupled to an antenna (not shown). The memory stores information about the item with which the NFC label 108 is associated. A device reading a NFC label 108 obtains the information stored in the memory. With no power source of its own, each NFC label 108 is considered passive, drawing power to operate from the NFC-enabled device reading that NFC label 108. Alternatively, the NFC labels 108 can be active devices, each having a power source to transmit the information stored in the memory (and to receive data from other NFC-enabled devices).

In the example shown in FIG. 1, NFC label 108a is associated with the items 106 on shelf 104a, NFC label 108b is associated with items on the shelf 104b (currently none, as the shelf is empty), and NFC label 108c is associated with the item 106 on the shelf 104c. As shown, the NFC labels 108 are disposed on the forward-facing edges of the shelves 104. Alternative locations for placement of the NFC labels 108 may be practiced without departing from the principles described herein. For example, an NFC label can be affixed to a signboard sitting atop a support surface.

The enterprise 100 further includes a computing system 110 having a server system 112 in communication with a database 114 and an access point 116. The computing system 110 may be connected to or part of a network, for example, a local-area network (LAN), metro-area networks (MAN), and wide-area networks (WAN), such as the Internet or World Wide Web. The computing system 110 can have more or fewer components than those shown (e.g., more server systems, no separate database, no separate access point, or more databases).

In one embodiment, the server system 112 is a database server that is in communication with the database 114. Communication between the server system 112 and the databases 114 can occur over a direct physical link 115, or over a LAN, MAN, WAN, etc. The database 114 represents one or more databases for storing information about products (i.e., items) offered by the enterprise 100 and about enterprise personnel (e.g., employees).

The access point 116 includes a radio-frequency transceiver 118 in communication with an antenna 120. Using radio-frequency communications (e.g., cellular network, Wi-Fi, BLUETOOTH®), the access point 116 can be in radio communication with mobile devices 122 used by shoppers and enterprise personnel. In addition, the access point 116 is in communication with the server system 112 to forward thereto communications received by the antenna 120 from a mobile device 122 and to transmit by the antenna 120 communications received from the server system 112 intended for a mobile device 122.

The mobile device 122 is generally an electronic device having a view screen 124, a processor (not shown), memory (not shown), an NFC chip (not shown), and a radio frequency (RF) transceiver (not shown). An example embodiment of the mobile device 122 is a smartphone. Other embodiments include, but are not limited to, laptop computers, wearable smart devices, such as watches and glasses. With the NFC chip and its own power source, the mobile device 122 is an active NFC device, capable of sending information to and receiving information from the NFC labels 108 placed on the shelves 104 using radio signals 126. With the RF transceiver, the mobile device 122 is able to exchange RF communications 128 with the access point 116.

The mobile device 122 may also have an application program (“app”)—stored in memory and executed by the processor—that facilitates self-shopping (the shopper acquires this app as previously described in order to take advantage of the self-shopping principles described herein; enterprise personnel may or may not have this app). The app displays information about the item, acquired from either the NFC label 108 or the server system 112, on the view screen 124.

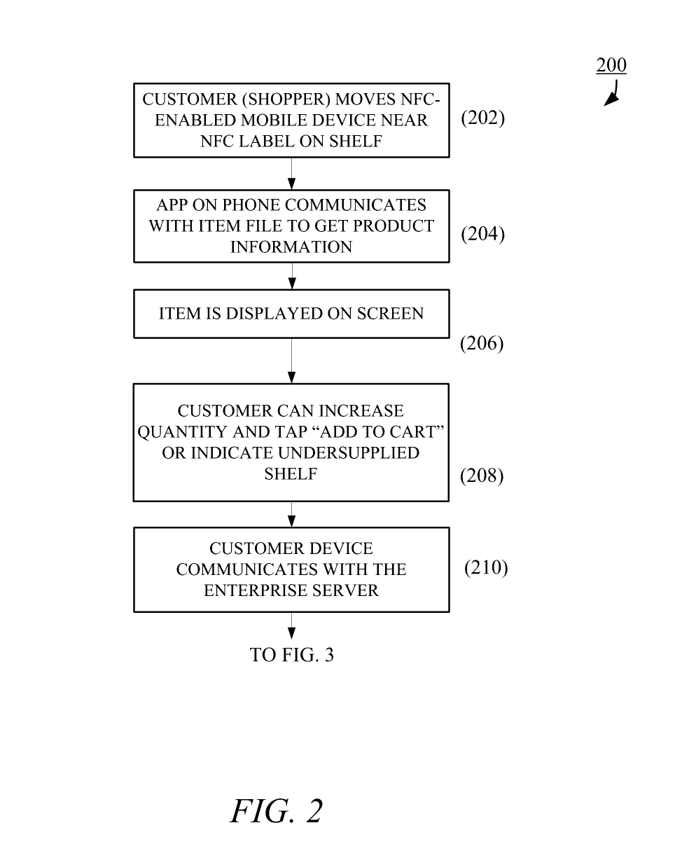

FIG. 2 shows an embodiment of a process 200 for facilitating self-shopping in the enterprise 100. In the description of the process 200, reference is made to the elements described in connection with FIG. 1. In step 202, a shopper moves an NFC-enabled smartphone 122 close enough to an NFC label 108 on a shelf 104 to exchange communications 126. The NFC label 108 is associated with an item of interest to the shopper. From the communication exchange, the app running on the smartphone 122 acquires information about the item from the scanned NFC label 108. Such information can include, for example, an identifier uniquely associated with the item and a brief description of the item. The smartphone 122 sends (step 204) the information acquired from the NFC label to the server system 112 (through the access point 116). Based on this information, the server system 112 accesses a file in the database 114 related to the item. The file access obtains product information about the item, which the server system 112 sends back to the smartphone 122. The product information appears (step 206) on the view screen 124 of the smartphone 122.

The shopper can indicate (step 208) the desired quantity and tap “add to cart”; alternatively, the shopper can indicate that the shelf 104 has an insufficient quantity of the desired item (e.g., a graphical button may be on the screen that permits the shopper to take this action). When the shopper taps “add to cart”, this action signifies the shopper has taken possession of the desired quantity of items and physically placed them in a shopping cart, box, or bag.

When the shopper indicates the shelf is undersupplied—for example, the shelf 104b is empty—this action signifies the shopper was unable to find the desired quantity on the shelf. In response to taking this action, the app may prompt the shopper to provide the quantity of items sought, but presently unavailable on the shelf. As used herein, a shelf is considered to have an insufficient quantity of items when the shelf is empty, has fewer items than are desired by the shopper, or has fewer items than a threshold quantity predetermined by the enterprise.

The app transmits (step 210) the desired quantity and selected action to the server system 112. When the shopper taps “add to cart”, a radio frequency communication from the smartphone 122 to the computing system 110 can convey the quantity added to the shopping cart. When the shopper reports an under stocked shelf, a radio frequency communication from the smartphone 122 to the computing system 110 notifies the enterprise of the undersupplied shelf and can convey the quantity shortfall.

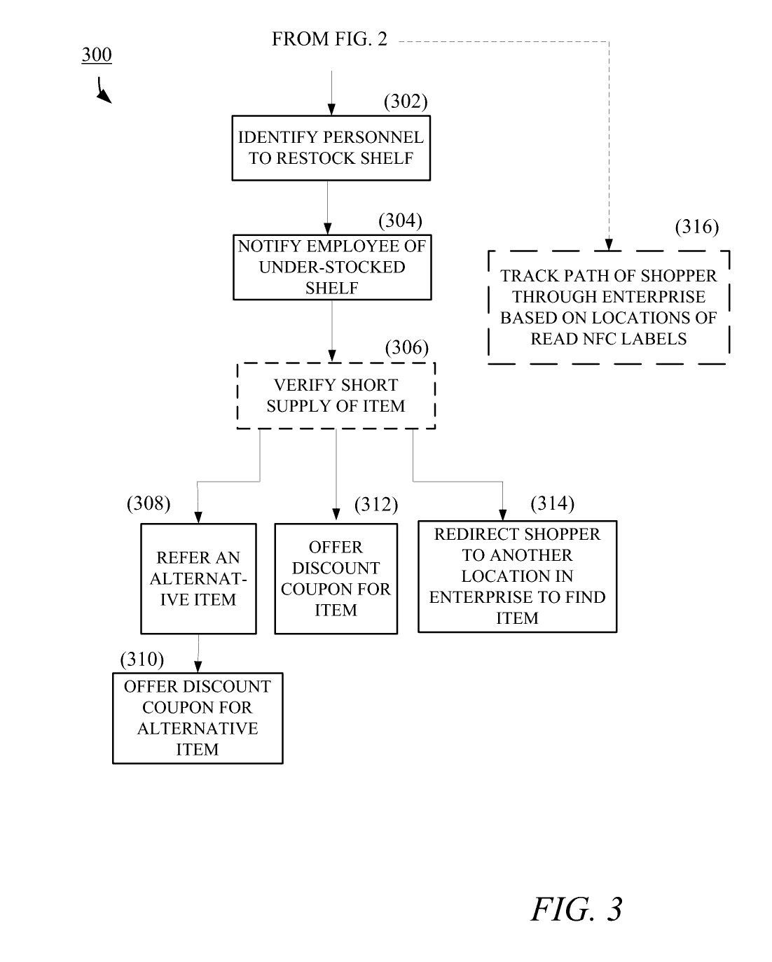

FIG. 3 shows an embodiment of a process 300 for enhancing the shopping experience of a shopper who finds a shelf of desired items to have an insufficient number of items. In response to receiving notice of an undersupplied shelf, the server system 112 accesses the database 114 to determine (step 302) the personnel who should be notified of the under stocked shelf, the location of the understocked shelf, and whether inventory has more of the item. The server system 112 sends (step 304) an electronic message to the identified personnel (the message can go simultaneously to multiple individuals) alerting the personnel of the under stocked or empty shelf. The electronic message can be, for example, an email message or a text message. The message may include the location of the shelf and the number of items available in inventory. The server system 112 may also send a return message to the mobile device 122 of the shopper indicating that an employee has been notified to restock the shelf.

In addition, the enterprise may verify (step 306) whether the shelf is in short supply for the associated item. For example, the notified personnel can physically visit the shelf to confirm the number of items, if any, presently on the shelf. After verifying the shelf is in short supply, the employee can communicate with the server system 112 (e.g., with RF communications), confirming the findings of the shopper.

In one embodiment, the server system 112 refers (step 308) an alternative item to the shopper in response to the confirmation from the employee. This server system 112 can be programmed to take this course of action when the server system 112 determines that inventory does not have the desired item. In addition, the server system 112 may refer the alternative item to the shopper irrespective of whether personnel confirms the current shelf quantity or is even notified of the under stocked shelf. A discount coupon for the alternative item may accompany (step 310) the referral of the alternative item. The presenting of the discount coupon may be contingent upon confirming the shelf is understocked.

Instead of, or in addition to, referring the alternative item, the server system 112 can offer (step 312) a discount coupon for the under stocked item. The offer of this discount coupon may be contingent upon confirming the shelf is understocked. In addition, the server system 112 may offer this discount coupon irrespective of whether personnel is notified of the under stocked shelf.

The server system 112 can send a message to the shopper, redirecting (step 314) the shopper to another location within the enterprise 100 where the item can be located. The server system 112 can determine this location from a search of the database 114. If the enterprise does not have the item, the server system 112 can redirect the shopper to a remote enterprise location that has the item in stock. Each redirection message can accompany the referral of an alternative item, offer of a discount coupon for the alternative item, offer of a discount coupon for the undersupplied item, or any combination thereof.

In one embodiment, shown in phantom, the server system 112 tracks (step 316) a path of the shopper through the enterprise 100 based on the locations of the NFC labels 108 read by the mobile device 122 of the shopper and communicated to the server system.

In addition, the server system 112 may itself dynamically determine that the supply of items of a particular shelf has fallen to a level requiring restocking—without any message from the shopper to that effect. For example, the server system 112 can maintain a current count of items on the shelf, and reduce that count each time a shopper adds a number of items to the electronic shopping cart. When the present count falls below a predefined number, the server system 112 notifies personnel that the shelf requires restocking.

As will be appreciated by one skilled in the art, aspects of the present invention may be embodied as a system, method, and computer program product. Thus, aspects of the present invention may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

Any combination of one or more computer readable medium(s) may be utilized. The computer readable medium may be a computer readable signal medium or a computer readable storage medium. The computer readable medium may be a non-transitory computer readable storage medium, examples of which include, but are not limited to, an electronic, magnetic, optical, electromagnetic, infrared, or semiconductor system, apparatus, or device, or any suitable combination thereof.

As used herein, a computer readable storage medium may be any tangible medium that can contain or store a program for use by or in connection with an instruction execution system, apparatus, device, computer, computing system, computer system, or any programmable machine or device that inputs, processes, and outputs instructions, commands, or data. A non-exhaustive list of specific examples of a computer readable storage medium include an electrical connection having one or more wires, a portable computer diskette, a floppy disk, a hard disk, a random access memory (RAM), a read-only memory (ROM), a USB flash drive, an non-volatile RAM (NVRAM or NOVRAM), an erasable programmable read-only memory (EPROM or Flash memory), a flash memory card, an electrically erasable programmable read-only memory (EEPROM), an optical fiber, a portable compact disc read-only memory (CD-ROM), a DVD-ROM, an optical storage device, a magnetic storage device, or any suitable combination thereof.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium is not a computer readable propagating signal medium or a propagated signal.

Program code may be embodied as computer-readable instructions stored on or in a computer readable storage medium as, for example, source code, object code, interpretive code, executable code, or combinations thereof. Any standard or proprietary, programming or interpretive language can be used to produce the computer-executable instructions. Examples of such languages include C, C++, Pascal, JAVA, BASIC, Smalltalk, Visual Basic, and Visual C++.

Transmission of program code embodied on a computer readable medium can occur using any appropriate medium including, but not limited to, wireless, wired, optical fiber cable, radio frequency (RF), or any suitable combination thereof.

The program code may execute entirely on a user's device, partly on the user's device, as a stand-alone software package, partly on the user's device and partly on a remote computer or entirely on a remote computer or server. Any such remote computer may be connected to the user's device through any type of network, including a local area network (LAN) or a wide area network (WAN), or the connection may be made to an external computer (for example, through the Internet using an Internet Service Provider).

Additionally, the methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like. In general, any device capable of implementing a state machine that is in turn capable of implementing the proposed methods herein can be used to implement the principles of this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The methods illustrated herein however can be readily implemented in hardware and/or software using any known or later developed systems or structures, devices and/or software by those of ordinary skill in the applicable art from the functional description provided herein and with a general basic knowledge of the computer and image processing arts.

Moreover, the disclosed methods may be readily implemented in software executed on programmed general-purpose computer, a special purpose computer, a microprocessor, or the like. In these instances, the systems and methods of this invention may be implemented as program embedded on personal computer such as JAVA® or CGI script, as a resource residing on a server or graphics workstation, as a plug-in, or the like. The system may also be implemented by physically incorporating the system and method into a software and/or hardware system.

While the aforementioned principles have been described in conjunction with a number of embodiments, it is evident that many alternatives, modifications, and variations would be or are apparent to those of ordinary skill in the applicable arts. Accordingly, it is intended to embrace all such alternatives, modifications, equivalents, and variations that are within the spirit and scope of this disclosure.

What is claimed is:

1. A method of facilitating self-shopping, comprising:
receiving, at a computing system, a radio frequency (RF) communication conveying information read by a mobile device from a near-field communication (NFC) label coupled to a shelf;
determining, by the computing system, an item associated with the NFC label based on the information conveyed by the RF communication;
determining, by the computing system, in response to the RF communication, that the shelf has an insufficient quantity of the item; and
automatically transmitting, by the computing system, in response to determining that the shelf has an insufficient quantity of the item, an electronic message to personnel indicating that the shelf requires restocking of the item.

2. The method of claim 1, wherein the information conveyed by the RF communication includes a quantity of the item added to an electronic cart by a user of the mobile device.

3. The method of claim 2, further comprising computing the quantity of the item remaining on the shelf in response to the quantity of the item added to the electronic cart by the user of the mobile device; and wherein the computing system determines the shelf has an insufficient quantity of the item when the computed quantity is less than a predefined number.

4. The method of claim 1, further comprising offering an alternative item if the RF communication indicates the shelf has an insufficient quantity of the item.

5. The method of claim 4, further comprising providing a discount coupon for the alternative item.

6. The method of claim 1, further comprising redirecting a user of the mobile device to a different location within the enterprise to find the item if the RF communication indicates the shelf has an insufficient quantity of the item.

7. The method of claim 1, further comprising tracking a path through the enterprise taken by a user of the mobile device based on each location in the enterprise where the mobile device communicates with the computing system in response to reading an NFC label.

8. A system for facilitating self-shopping in an enterprise, comprising:
a support surface for supporting items, the support surface having a near-field communication (NFC) label coupled thereto;
a computing system comprising a receiver that receives a radio frequency (RF) communication transmitted by a mobile device in response to the mobile device being placed near enough to the NFC label to read the NFC label, the RF communication conveying information read from the NFC label, the computing system comprising a processor programmed to i) determine an item associated with the NFC label based on the information conveyed by the RF communication, ii) determine, in response to the RF communication, that the support surface has an insufficient quantity of the item, and iii) cause a message to be automatically transmitted an electronic message to personnel indicating that the shelf requires restocking of the item.

9. The system of claim 8, wherein the information conveyed by the RF communication includes a quantity of the item added to an electronic cart by a user of the mobile device.

10. The system of claim 8, wherein the processor is further programmed to offer an alternative item if the RF communication indicates the support surface has an insufficient quantity of the item.

11. The system of claim 10, wherein the processor is further programmed to provide a discount coupon for the alternative item.

12. The system of claim 10, wherein the processor is further programmed to redirect a user of the mobile device to a different location within the enterprise to find the item if the RF communication indicates the support surface has an insufficient quantity of the item.

13. The system of claim 8, wherein the processor is further programmed to track a path taken by a user of the mobile device through the enterprise based on each location in the enterprise where the mobile device communicates with the computing system in response to reading an NFC label.

14. Computer program product for facilitating self-shopping, the computer program product comprising:
a non-transitory computer readable storage medium having computer readable program code embodied therewith, the computer readable program code comprising:
computer readable program code that, if executed, receives a radio frequency (RF) communication conveying information read by a mobile device from a near-field communication (NFC) label coupled to a shelf;
computer readable program code that, if executed, determines an item associated with the NFC label based on the information conveyed by the RF communication;
computer readable program code that, if executed, determines in response to the RF communication that the shelf has an insufficient quantity of the item; and
computer readable program code that, if executed, automatically transmits an electronic message to personnel indicating that the shelf requires restocking of the item.

15. The computer program product of claim 14, wherein the information conveyed by the RF communication includes a quantity of the item added to an electronic cart by a user of the mobile device.

16. The computer program product of claim 15, further comprising:
computer readable program code that, if executed, computes the quantity of the item remaining on the shelf in response to the quantity of the item added to the electronic cart by the user of the mobile device; and
computer readable program code that, if executed, determines the shelf has an insufficient quantity of the item when the computed quantity is less than a predefined number.

17. The computer program product of claim 14, further comprising computer readable program code that, if executed, offers an alternative item if the RF communication indicates the shelf has an insufficient quantity of the item.

18. The computer program product of claim 17, further comprising computer readable program code that, if executed, provides a discount coupon for the alternative item.

19. The computer program product of claim 14, further comprising computer readable program code that, if executed, redirects a user of the mobile device to a different location within the enterprise to find the item if the RF communication indicates the shelf has an insufficient quantity of the item.

20. The computer program product of claim 14, further comprising computer readable program code that, if executed, tracks a path taken by a user of the mobile device through the enterprise based on each location in the enterprise where the mobile device communicates with the computing system in response to reading an NFC label.
